(19) United States
(12) Patent Application Publication
(10) Pub. No.: US 2015/0285991 A1
(43) Pub. Date: Oct. 8, 2015

(54) COATED POLYMER CLAD OPTICAL FIBER

(71) Applicant: FUJIKURA LTD., Tokyo (JP)

(72) Inventor: Shingo MATSUSHITA, Sakura-shi (JP)

(73) Assignee: FUJIKURA LTD., Tokyo (JP)

(21) Appl. No.: 14/679,184

(22) Filed: Apr. 6, 2015

(30) Foreign Application Priority Data
Apr. 8, 2014 (JP) 2014-079423

(51) Int. Cl. G02B 6/02; G02B 6/036

(52) U.S. Cl. CPC G02B 6/02033; G02B 6/02395; G02B 6/03638

(57) ABSTRACT

A coated polymer clad optical fiber of the invention includes: a polymer cladding layer that is formed around an optical fiber made of silica-based glass and has a refractive index lower than the refractive index of the silica-based glass; and a protective coating layer formed around the polymer cladding layer. The thickness of the polymer cladding layer is 3.0 or more times the thickness of the protective coating layer.

### CROSS-REFERENCE TO RELATED APPLICATION

This application is based on and claims priority from Japanese Patent Application No. 2014-079423 filed on Apr. 8, 2014, the contents of which are incorporated herein by reference in their entirety.

### BACKGROUND OF THE INVENTION

1. Field of the Invention

The present invention relates to a coated polymer clad optical fiber used in an optical fiber, particularly, used in a fiber laser, or the like.

2. Description of the Related Art

Optical fibers that are required to have high numerical aperture (hereinbelow, referred to as “high NA”) are used, particularly, it is necessary for an optical fiber used in a fiber laser (hereinbelow, referred to “laser fiber”) to transmit high density light.

In recent years, power of the fiber laser further increases, a fiber laser is in a commercial reality which realizes a kW class optical output such that it is used to cut or weld a metal, heat melting, or the like, a further souped-up optical fiber is required.

In order to realize an increase in power of the fiber laser, it is necessary to launch a further-large amount of pumping light into an optical fiber, and it is desirable to develop an optical fiber that realizes a high NA such that the NA is greater than or equal to 0.5 (hereinbelow, “high NA” in the invention means an NA of greater than or equal to 0.5).

As a polymer cladding material used to form a laser fiber, ultraviolet curable fluorinated acrylate resins are mainly used.

Such ultraviolet curable fluorinated acrylate resins originally have a low level of adhesion with respect to glass. Furthermore, in the case of adding a large amount of fluorine into the resins in order to realize a high NA, the level of adhesion with respect to glass becomes more degraded.

For this reason, even if a high NA can be realized as a result of using ultraviolet curable resins, there is a problem in that the transmission loss rapidly deteriorates in high humidity.

Because of this, in the disclosure of Japanese Unexamined Patent Application, First Publication No. 2013-41060, as a result of using, as a polymer cladding material, a cladding material containing a perfluoroether polymer that is cured by cross-linking due to a hydrosilylation reaction, a high NA is realized and the cladding material has hydrophobicity; additionally, as a result of introducing an alkoxy group that combines with silicon atoms in the cladding thereto, the moisture resistance is improved.

Conventionally, it is said that it is preferable that the fracture stress (tensile strength) of the polymer cladding material be greater than or equal to 10 MPa.

However, in the case of increasing an amount of fluorine that is to be introduced into a polymer cladding material in order to realize a high NA, the fracture stress of the resin cannot be sufficiently increased such that, for example, the fracture stress becomes less than or equal to 1 MPa.

Also, regarding a laser fiber, a screening test is carried out which previously removes a low-strength portion in order to ensure the mechanical reliability thereof. However, in the case of a polymer cladding material having a low fracture stress, due to an external force such as ironing which is applied thereto in the screening test, a polymer cladding material is broken or peeled off from glass, and there are problems in that pumping light guided in the glass cannot be confined and leakage of the excitation light occurs.

### SUMMARY OF THE INVENTION

The invention was conceived in view of the above-described circumstances and an object thereof is to provide a coated polymer clad optical fiber which has a high level of resistance to ironing and can reduce excitation loss.

A coated polymer clad optical fiber according to an first aspect of the invention includes: a polymer cladding layer formed around an optical fiber made of silica-based glass, the polymer cladding layer having a refractive index lower than the refractive index of the silica-based glass; and a protective coating layer formed around the polymer cladding layer; wherein the thickness of the polymer cladding layer is 3.0 or more times the thickness of the protective coating layer.

In the coated polymer clad optical fiber according to the first aspect of the invention, it is preferable that the protective coating layer have a type D durometer hardness of greater than or equal to 20.

In the coated polymer clad optical fiber according to the first aspect of the invention, it is preferable that the resin used to form the protective coating layer be a thermosetting resin.

In the coated polymer clad optical fiber according to the first aspect of the invention, it is preferable that the resin used to form the polymer cladding layer be a thermosetting resin.

A coated polymer clad optical fiber according to a second aspect of the invention includes: a polymer cladding layer formed around an optical fiber made of silica-based glass, the polymer cladding layer having a refractive index lower than the refractive index of the silica-based glass; at least one or more buffer layers formed around the polymer cladding layer; and a protective coating layer formed around the buffer layers, wherein the total thickness of the polymer cladding layer and the buffer layers is 1.5 or more times the thickness of the protective coating layer.

In the coated polymer clad optical fiber according to the second aspect of the invention, it is preferable that the protective coating layer have a type D durometer hardness of greater than or equal to 20.

In the coated polymer clad optical fiber according to the second aspect of the invention, it is preferable that a resin used to form the protective coating layer be a thermosetting resin.

In the coated polymer clad optical fiber according to the second aspect of the invention, it is preferable that the resin used to form the buffer layers have a type A durometer hardness of 20 to 80.

According to the above-described aspects of the invention, it is possible to provide a coated polymer clad optical fiber which has a high level of resistance to ironing and can reduce an excitation loss.

### BRIEF DESCRIPTION OF THE DRAWINGS

FIG. 1 is a cross-sectional view showing an example of a coated polymer clad optical fiber according to a first embodiment.

FIG. 2A is a cross-sectional view showing the case where an external force is applied to an optical fiber including a soft protection resin layer.

FIG. 2B is a cross-sectional view showing the case where an external force is applied to an optical fiber including a hard protection resin layer.

FIG. 3 is a cross-sectional view showing an example of a coated polymer clad optical fiber according to a second embodiment.

FIG. 4 is a chart showing, as an example, the relationships between the thickness ratios according to the first embodiment and excitation losses.

FIG. 5 is a chart showing, as an example, the relationships between the thickness ratios according to the second embodiment and excitation losses.

### DETAILED DESCRIPTION OF THE INVENTION

Hereinafter, preferred embodiments will described with reference to drawings.

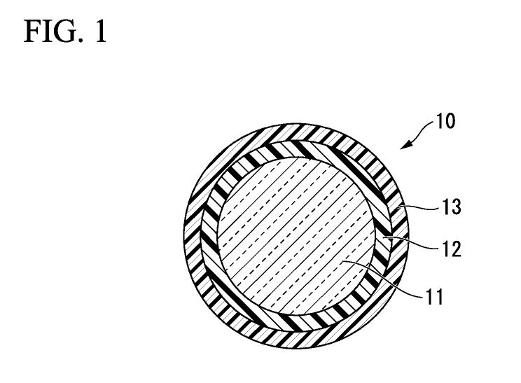

FIG. 1 is a cross-sectional view schematically showing a coated polymer clad optical fiber 10 according to a first embodiment.

The coated polymer clad optical fiber 10 has a cross-section structure in which a polymer cladding layer 12 is formed around an optical fiber made of silica-based glass 11 and a protective coating layer 13 is formed around the polymer cladding layer 12.

The polymer cladding layer 12 has a refractive index lower than the refractive index of silica-based glass forming the optical fiber 11.

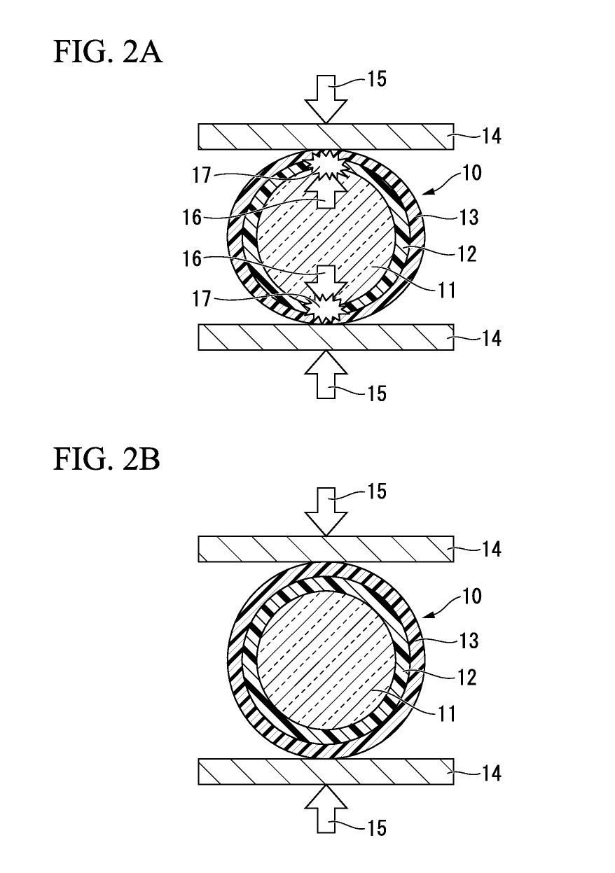

FIGS. 2A and 2B are schematic views showing the cases where an external force is applied to the coated polymer clad optical fiber 10.

FIG. 2A shows the case where a resin used to form the protective coating layer 13 is soft.

FIG. 2B shows the case where a resin used to form the protective coating layer 13 is hard.

In the case where the protective coating layer 13 is soft, as a result of an external force that is applied to the coated polymer clad optical fiber 10, both the protective coating layer 13 and the polymer cladding layer 12 are deformed, and the polymer cladding layer 12 is thereby broken.

For example, in the case where the coated polymer clad optical fiber 10 sandwiched between a pair of plate-shaped members 14 and an external force 15 is applied thereto, destruction 17 occurs in the polymer cladding layer 12 due to the opposed action 16 received from the optical fiber 11 made of hard glass and the external force 15 received from the plate-shaped members 14.

On the other hand, in the case where the protective coating layer 13 is hard, since the protective coating layer 13 is hardly deformed even where an external force is applied to the coated polymer clad optical fiber 10, the polymer cladding layer 12 is not deformed, and breaking of the polymer cladding layer 12 never happens.

In order to ensure sufficiently resistance to ironing, it is preferable to form the protective coating layer 13 by use of a resin having a Type D durometer hardness of 20 or more (the hardness is greater than or equal to D20) as defined by JIS K 6253.

More preferably, as a result of forming the protective coating layer 13 by use of a hard resin having a Type D durometer hardness of 70 or more, it is possible to improve resistance to ironing (in the description below, the hardness of the invention is a hardness that is measured by durometer hardness measurement, and a Type A durometer and Type D durometer are simply referred to as A and D, respectively).

However, in order to improve resistance to ironing, in the case of using a hard resin to form the protective coating layer 13, although the resistance to ironing is improved, an excitation loss is sometimes degraded.

Particularly, in the case of forming the protective coating layer 13 by use of a thermosetting resin such as a silicone resin or a polyimide resin in order to improve the heat resistance of the coated polymer clad optical fiber 10, the excitation loss is significantly deteriorated.

The reason that, an excitation loss is significantly deteriorated as a result of forming the protective coating layer 13 by use of a thermosetting resin having a high hardness, is considered to be as follows.

When an optical fiber is coated with a thermosetting resin, a curing reaction mechanism varies depending on the kinds of resin. In all cases, after the periphery of an optical fiber is coated with a resin, as a result of heating the resin under high temperature conditions using a bridging device such as an electrically-heated reactor, curing of the resin is prompted, and a state of the resin is thereby changed from a flowable state to a solid state.

At this time, since the structure of the resin is solidified in a high temperature state, after the optical fiber coated with the resin is discharged from the bridging device, heat shrinkage occurs during the lowering of the resin temperature to room temperature.

In the case of using a resin having a high hardness, it is conceivable that a lateral pressure that is applied to the polymer cladding layer 12 located inside the protective coating layer 13 excessively increases due to the heat shrinkage of the protective coating layer 13, and the excitation loss thereby increases (deterioration).

Based on the above consideration, the inventor has been intensively researched to reduce the effect of the lateral pressure applied from the protective coating layer 13 to the polymer cladding layer 12. As a result, in the invention, it is found out that the ratio of the polymer cladding layer 12 to the protective coating layer 13 is correlated to excitation loss, and that, as a result of setting the thickness of the polymer cladding layer 12 to be 3.0 or more times the thickness of the protective coating layer 13, it is possible to manufacture a coated polymer clad optical fiber 10 which has heat resistance and achieves both a resistance to ironing and a low degree of excitation loss.

As a resin used to form the polymer cladding layer 12 (a polymer cladding material), a fluorine resin, a fluorinated acrylate resin, or the like is adopted.

The polymer cladding material is a ultraviolet curable resin, a thermosetting resin, or the like. In terms of heat resistance, it is preferable to use a thermosetting resin as the polymer cladding material.

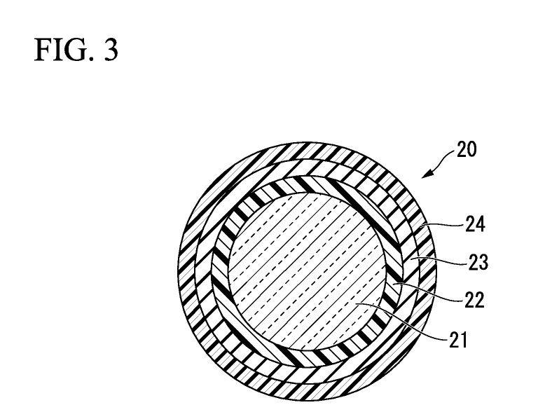

FIG. 3 is a cross-sectional view schematically showing a coated polymer clad optical fiber 20 according to a second embodiment.

The coated polymer clad optical fiber 20 has a cross-section structure in which a polymer cladding layer 22 is formed around an optical fiber 21 made of silica-based glass, at least one or more buffer layer 23 is formed around the polymer cladding layer 22, and a protective coating layer 24 is formed around the buffer layer 23.

The polymer cladding layer 22 has a refractive index lower than the refractive index of silica-based glass forming the optical fiber 21.

The resin (a polymer cladding material) used to form the polymer cladding layer 22 may be the same as that in the first embodiment.

A polymer cladding material is expensive more than a generally-used resin. Therefore, it is not preferable to increase the thickness of the polymer cladding layer 22 because the cost thereof increases.

Consequently, the inventor researched the adoption of a three-layered structure having the buffer layer 23 interposed between the polymer cladding layer 22 and the protective coating layer 24 and thereby realize a fiber structure that can satisfy both resistance to ironing and a low degree of excitation loss while reducing the thickness of the polymer cladding layer 22. As a result, it is found out that, by setting the total thickness of the polymer cladding layer 22 and the buffer layer 23 to be 1.5 or more times the thickness of the protective coating layer 24, the coated polymer clad optical fiber 20 can be manufactured which satisfies both resistance to ironing and a low degree of excitation loss. The coated polymer clad optical fiber of the second embodiment is realized based on the above consideration.

Particularly, the hardness of a resin used to form the buffer layer 23 is preferably approximately A20 to A80, preferably A20 or more and A80 or less, and more preferably less than or equal to A30.

In the case of forming the buffer layer 23 by use of a resin made of gel or grease which has a hardness lower than A20 and is measured by penetration, since the protective coating layer 24 is deformed by ironing, the external shape in appearance of the optical fiber cannot be maintained and a resistance to ironing cannot be obtained.

Adversely, in the case of forming the buffer layer 23 by use of a resin which has a Type D durometer hardness of higher than A80, the effect of the buffer layer 23 cannot be sufficiently obtained, and a function due to the three-layered structure cannot be obtained.

In other cases where the optical fiber has a three-layered coating structure, the thickness ratio of the polymer cladding layer 22 to the buffer layer 23 is not particularly limited, and the number of the buffer layer 23 may be greater than or equal to two.

It is preferable that the thickness of the polymer cladding layer 22 be greater than or equal to 3 μm.

In the second embodiment, the resin used to form the protective coating layer 24 may be the same as that in the first embodiment.

It is preferable that the hardness of the resin used to form the protective coating layer 24 be greater than or equal to D20.

Furthermore, it is preferable that the resin used to form the protective coating layer 24 be a thermosetting resin.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

Each of the optical fibers 11 and 21 may function as a glass core relative to the polymer cladding layers 12 and 22. Each of the optical fibers 11 and 21 may include core and cladding.

Silica-based glass forming the optical fibers 11 and 21 may be made of pure silica glass or may be made of silica glass into which fluorine (F), germanium (Ge), or the like is doped.

An optical fiber which is used to transmit signal light preferably include: a single-layer glass cladding provided around a glass core; and a polymer cladding layer provided around the glass cladding.

An optical fiber which is used to transmit pumping light preferably include a polymer cladding layer that is directly provided on the periphery of a glass core.

In the case of preventing reflected light from entering into a light source such as a laser diode (LD), a two-layered glass cladding (inner cladding and outer cladding) may be provided around a glass core, and a polymer cladding layer may be provided around a glass cladding.

Typically, the outer diameter (fiber diameter, glass diameter) of each of the optical fibers 11 and 21 is 125 μm. The invention is obviously applicable to optical fibers having the other diameter.

Generally, as the glass diameter becomes smaller in an optical fiber, the number of light reflection at the boundary face between the polymer cladding layer and the glass increases. Accordingly, in the case of using the same polymer cladding material, a value of the excitation loss which can reach becomes larger. However, the value of the excitation loss which is caused by the cover member shown in the embodiments of invention does not depend on the fiber diameter.

### EXAMPLES

Hereinbelow, the invention will be particularly described with reference to Examples.

### Test Example of First Embodiment

In the above-described first embodiment, a resin having a hardness of D20 or more is used to form the protective coating layer 13, and the thickness of the polymer cladding layer 12 is 3.0 or more times the thickness of the protective coating layer 13. As a result, it is possible to manufacture the coated polymer clad optical fiber 10 that satisfies both resistance to ironing and a low degree of excitation loss.

Of the manufactured coated polymer clad optical fibers 10 shown in Tables 1 to 6, the initial character denoted by “C” of the number of the coated polymer clad optical fibers are Comparative Examples. That is, the coated polymer clad optical fibers shown by C1A to C39A represent Comparative Examples.

In Tables 1 to 6, the units of “FIBER DIAMETER”, “CLADDING DIAMETER”, “PROTECTIVE COATING DIAMETER”, “THICKNESS OF CLADDING”, and “THICKNESS OF PROTECTIVE COATING LAYER” are “μ”, the units of “EXCITATION LOSS” and “INCREMENT IN EXCITATION LOSS” are “dB/km”, and the units thereof which are commonly used are omitted.

The “FIBER DIAMETER” represents a glass diameter of the optical fiber 11. “CLADDING DIAMETER” and “THICKNESS OF CLADDING” represent the outer diameter and the thickness of the polymer cladding layer 12, respectively. “PROTECTIVE COATING DIAMETER” and “THICKNESS OF PROTECTIVE COATING LAYER” represent the outer diameter and the thickness of the protective coating layer 13, respectively.

“THICKNESS RATIO” is the ratio of “THICKNESS OF CLADDING” to “THICKNESS OF PROTECTIVE COATING LAYER”.

### Test Example 1

### Reference Numbers 1A to 2A and C1A to C3A

The optical fiber 11 having a fiber diameter of 125 μm was prepared. With respect to the optical fiber, the polymer cladding layer 12 was formed by use of a thermosetting resin having a refractive index of 1.35 or less, and the protective coating layer 13 was formed by use of a thermosetting resin having a hardness of D75. As a result, the coated polymer clad optical fiber 10 having a high NA was produced.

The thickness of the polymer cladding layer 12 and the thickness of the protective coating layer 13 were varied, the coated polymer clad optical fibers 10 using them were produced, and the excitation losses thereof were measured. As shown in Table 1, under the condition of the coated polymer clad optical fiber 10 in which the thickness of the polymer cladding layer 12 is 3 or more times the thickness of the protective coating layer 13, the value of the excitation loss was stable at approximately 3 dB/km.

Next, regarding Numbers 1 A and 2A of the coated polymer clad optical fibers 10 (having overall length of 20 km), in order to evaluate resistance to ironing of the produced coated polymer clad optical fibers 10, the coated polymer clad optical fibers were subjected to rewinding while being extended so as to be longer than the original length thereof by 2% of the length. Thereafter, visible light was launched into the optical fiber 11, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 1

| | | | | | THICK- | DEGREE OF | | | | |
|---|---|---|---|---|---|---|---|---|---|---|
| | | CLAD- | PROTEC- | THICK- | NESS OF | HARDNESS OF | | | GENERA- | INCREMENT |
| | FIBER | DING | TIVE | NESS OF | PROTECTIVE | PROTECTIVE | THICK- | EXCITA- | TION OF | IN EXCITA- |
| NUM- | DIAM- | DIAM- | COATING | CLAD- | COATING | COATING | NESS | TION | BRIGHT | TION |
| BER | ETER | ETER | DIAMETER | DING | LAYER | LAYER | RATIO | LOSS | SPOT | LOSS |
| 1A | 125 | 220 | 250 | 47.5 | 15 | D75 | 3.2 | 3.1 | ABSENCE | 0 |
| 2A | 125 | 220 | 240 | 47.5 | 10 | D75 | 4.8 | 3 | ABSENCE | 0 |
| C1A | 125 | 177 | 250 | 26 | 36.5 | D75 | 0.7 | 130 | — | — |
| C2A | 125 | 180 | 235 | 27.5 | 27.5 | D75 | 1.0 | 105 | — | — |
| C3A | 125 | 180 | 230 | 27.5 | 25 | D75 | 1.1 | 86.45 | — | — |
| C4A | 125 | 190 | 230 | 32.5 | 20 | D75 | 1.0 | 45 | — | — |
| C5A | 125 | 197 | 230 | 36 | 16.5 | D75 | 2.2 | 24 | — | — |
| C6A | 125 | 200 | 230 | 37.5 | 15 | D75 | 2.5 | 12 | — | — |

### Test Example 2

### Reference Numbers 3A to 5A and C7A to C12A

With the exception that the fiber diameter is 80 μm, the coated polymer clad optical fiber 10 having high NA was produced in a way similar to the case of Test Example 1.

The excitation losses of the coated polymer clad optical fibers 10 were measured. As shown in Table 2, under the condition of the coated polymer clad optical fiber 10 in which the thickness of the polymer cladding layer 12 is 3 or more times the thickness of the protective coating layer 13, the value of the excitation loss was stable at approximately 10 dB/km.

Next, regarding Numbers 3A to 5A of the coated polymer clad optical fibers 10 (having overall length of 20 km), in order to evaluate resistance to ironing of the produced coated polymer clad optical fibers 10, the coated polymer clad optical fibers were subjected to rewinding while being extended so as to be longer than the original length thereof by 2% of the length. Thereafter, visible light was launched into the optical fiber 11, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 2

| | | | | | | DEGREE |
|---|---|---|---|---|---|---|
| | | | | | | OF |
| | | | | | THICKNESS | HARDNESS |
| | | | | | OF | OF |
| | | | PROTECTIVE | THICKNESS | PROTECTIVE | PROTECTIVE |
| | FIBER | CLADDING | COATING | OF | COATING | COATING |
| NUMBER | DIAMETER | DIAMETER | DIAMETER | CLADDING | LAYER | LAYER |
| 3A | 80 | 170 | 200 | 45 | 15 | D75 |
| 4A | 80 | 220 | 250 | 70 | 15 | D75 |
| 5A | 80 | 270 | 290 | 95 | 10 | D75 |
| C7A | 80 | 140 | 230 | 30 | 45 | D75 |
| C8A | 80 | 140 | 210 | 30 | 35 | D75 |
| C9A | 80 | 150 | 200 | 35 | 25 | D75 |
| C10A | 80 | 160 | 205 | 40 | 22.5 | D75 |
| C11A | 80 | 165 | 200 | 42.5 | 17.5 | D75 |
| C12A | 80 | 175 | 210 | 47.5 | 17.5 | D75 |

| | | | GENERATION | INCREMENT |
|---|---|---|---|---|
| | | | OF | IN |
| | THICKNESS | EXCITATION | BRIGHT | EXCITATION |
| NUMBER | RATIO | LOSS | SPOT | LOSS |
| 3A | 3.0 | 10 | ABSENCE | 0 |
| 4A | 4.7 | 9.8 | ABSENCE | 0 |
| 5A | 9.5 | 9.7 | ABSENCE | 0 |
| C7A | 0.7 | 130 | — | — |
| C8A | 0.9 | 105 | — | — |
| C9A | 1.4 | 70 | — | — |
| C10A | 1.8 | 38 | — | — |
| C11A | 2.4 | 20 | — | — |
| C12A | 2.7 | 15 | — | — |

### Test Example 3

### Reference Numbers 6A to 7A and Cl3A to Cl8A

With the exception that the fiber diameter is 400 μm, the coated polymer clad optical fiber 10 having high NA was produced in a way similar to the case of Test Example 1.

The excitation losses of the coated polymer clad optical fibers 10 were measured. As shown in Table 3, under the condition of the coated polymer clad optical fiber 10 in which the thickness of the polymer cladding layer 12 is 3 or more times the thickness of the protective coating layer 13, the value of the excitation loss was stable at approximately 3 dB/km.

Next, regarding Numbers 6A and 7A of the coated polymer clad optical fibers 10 (having overall length of 20 km), in order to evaluate resistance to ironing of the produced coated polymer clad optical fibers 10, the coated polymer clad optical fibers were subjected to rewinding while being extended so as to be longer than the original length thereof by 2% of the length. Thereafter, visible light was launched into the optical fiber 11, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 3

| | | | | | | DEGREE |
|---|---|---|---|---|---|---|
| | | | | | | OF |
| | | | | | THICKNESS | HARDNESS |
| | | | | | OF | OF |
| | | | PROTECTIVE | THICKNESS | PROTECTIVE | PROTECTIVE |
| | FIBER | CLADDING | COATING | OF | COATING | COATING |
| NUMBER | DIAMETER | DIAMETER | DIAMETER | CLADDING | LAYER | LAYER |
| 6A | 400 | 510 | 545 | 55 | 17.5 | D75 |
| 7A | 400 | 550 | 580 | 75 | 15 | D75 |
| C13A | 400 | 440 | 520 | 20 | 40 | D75 |
| C14A | 400 | 455 | 520 | 27.5 | 32.5 | D75 |
| C15A | 400 | 465 | 520 | 32.5 | 27.5 | D75 |
| C16A | 400 | 470 | 520 | 35 | 25 | D75 |
| C17A | 400 | 485 | 520 | 42.5 | 17.5 | D75 |
| C18A | 400 | 485 | 515 | 42.5 | 15 | D75 |

| | | | GENERATION | INCREMENT |
|---|---|---|---|---|
| | | | OF | IN |
| | THICKNESS | EXCITATION | BRIGHT | EXCITATION |
| NUMBER | RATIO | LOSS | SPOT | LOSS |
| 6A | 3.1 | 2.8 | ABSENCE | 0 |
| 7A | 5.0 | 2.9 | ABSENCE | 0 |
| C13A | 0.5 | 145 | — | — |
| C14A | 0.8 | 115 | — | — |
| C15A | 1.2 | 90 | — | — |
| C16A | 1.4 | 57 | — | — |
| C17A | 2.4 | 12 | — | — |
| C18A | 2.8 | 6 | — | — |

### Test Example 4

### Reference Numbers 8A to 9A and C19A to C24A

With the exception that the protective coating layer 13 is formed by use of a thermosetting resin having a hardness of D50, the coated polymer clad optical fiber 10 having high NA was produced in a way similar to the case of Test Example 1.

The excitation losses of the coated polymer clad optical fibers 10 were measured. As shown in Table 4, under the condition of the coated polymer clad optical fiber 10 in which the thickness of the polymer cladding layer 12 is 3 or more times the thickness of the protective coating layer 13, the value of the excitation loss was stable at approximately 3 dB/km.

Next, regarding Numbers 8A and 9A of the coated polymer clad optical fibers 10 (having overall length of 20 km), in order to evaluate resistance to ironing of the produced coated polymer clad optical fibers 10, the coated polymer clad optical fibers were subjected to rewinding while being extended so as to be longer than the original length thereof by 2% of the length. Thereafter, visible light was launched into the optical fiber 11, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 4

| | | | | | | DEGREE |
|---|---|---|---|---|---|---|
| | | | | | | OF |
| | | | | | THICKNESS | HARDNESS |
| | | | | | OF | OF |
| | | | PROTECTIVE | THICKNESS | PROTECTIVE | PROTECTIVE |
| | FIBER | CLADDING | COATING | OF | COATING | COATING |
| NUMBER | DIAMETER | DIAMETER | DIAMETER | CLADDING | LAYER | LAYER |
| 8A | 125 | 225 | 250 | 50 | 12.5 | D50 |
| 9A | 125 | 230 | 250 | 52.5 | 10 | D50 |
| C19A | 125 | 180 | 260 | 27.5 | 40 | D50 |
| C20A | 125 | 195 | 260 | 35 | 32.5 | D50 |
| C21A | 125 | 190 | 245 | 32.5 | 27.5 | D50 |
| C22A | 125 | 200 | 245 | 37.5 | 22.5 | D50 |
| C23A | 125 | 210 | 250 | 42.5 | 20 | D50 |
| C24A | 125 | 215 | 250 | 45 | 17.5 | D50 |

| | | | GENERATION | INCREMENT |
|---|---|---|---|---|
| | | | OF | IN |
| | THICKNESS | EXCITATION | BRIGHT | EXCITATION |
| NUMBER | RATIO | LOSS | SPOT | LOSS |
| 8A | 4.0 | 2.7 | ABSENCE | 0 |
| 9A | 5.3 | 2.8 | ABSENCE | 0 |
| C19A | 0.7 | 131 | — | — |
| C20A | 1.1 | 100 | — | — |
| C21A | 1.2 | 85 | — | — |
| C22A | 1.7 | 40 | — | — |
| C23A | 2.1 | 22 | — | — |
| C24A | 2.6 | 10 | — | — |

### Test Example 5

### Reference Numbers 10A to 11A and C25A to C31A

With the exception that the protective coating layer 13 is formed by use of a thermosetting resin having a hardness of D20, the coated polymer clad optical fiber 10 having high NA was produced in a way similar to the case of Test Example 1.

The excitation losses of the coated polymer clad optical fibers 10 were measured. As shown in Table 5, under the condition of the coated polymer clad optical fiber 10 in which the thickness of the polymer cladding layer 12 is 3 or more times the thickness of the protective coating layer 13, the value of the excitation loss was stable at approximately 3 dB/km.

Next, regarding Numbers 10A and 11A of the coated polymer clad optical fibers 10 (having overall length of 20 km), in order to evaluate resistance to ironing of the produced coated polymer clad optical fibers 10, the coated polymer clad optical fibers were subjected to rewinding while being extended so as to be longer than the original length thereof by 2% of the length. Thereafter, visible light was launched into the optical fiber 11, and whether or not the excitation light leaked was evaluated. As a result of the evaluation, it was observed that the leakage of the excitation light (generation of bright spot) occurred at 5 portions. However, it was observed the excitation loss thereof was not varied and excellent resistance to ironing was obtained. However, the resistances to ironing of Numbers 10A and 11A of the coated polymer clad optical fibers 10 were lower than that of Test Example 1 (D75) or Test Example 4 (D50) in the resistance to ironing.

TABLE 5

| | | | | | | DEGREE |
|---|---|---|---|---|---|---|
| | | | | | | OF |
| | | | | | THICKNESS | HARDNESS |
| | | | | | OF | OF |
| | | | PROTECTIVE | THICKNESS | PROTECTIVE | PROTECTIVE |
| | FIBER | CLADDING | COATING | OF | COATING | COATING |
| NUMBER | DIAMETER | DIAMETER | DIAMETER | CLADDING | LAYER | LAYER |
| 10A | 125 | 220 | 250 | 47.5 | 15 | D20 |
| 11A | 125 | 230 | 250 | 52.5 | 10 | D20 |
| C25A | 125 | 155 | 200 | 15 | 22.5 | D20 |
| C26A | 125 | 165 | 205 | 20 | 20 | D20 |
| C27A | 125 | 170 | 205 | 22.5 | 17.5 | D20 |
| C28A | 125 | 185 | 225 | 30 | 20 | D20 |
| C29A | 125 | 190 | 230 | 32.5 | 20 | D20 |
| C30A | 125 | 200 | 235 | 37.5 | 17.5 | D20 |
| C31A | 125 | 215 | 250 | 45 | 17.5 | D20 |

| | | | GENERATION | INCREMENT |
|---|---|---|---|---|
| | | | OF | IN |
| | THICKNESS | EXCITATION | BRIGHT | EXCITATION |
| NUMBER | RATIO | LOSS | SPOT | LOSS |
| 10A | 3.2 | 2.9 | PRESENCE | 0 |
| 11A | 5.3 | 2.8 | PRESENCE | 0 |
| C25A | 0.7 | 140 | — | — |
| C26A | 1.0 | 106 | — | — |
| C27A | 1.3 | 82 | — | — |
| C28A | 1.5 | 55 | — | — |
| C29A | 1.6 | 39 | — | — |
| C30A | 2.1 | 30 | — | — |
| C31A | 2.6 | 15 | — | — |

### Test Example 6

### Reference Numbers C32A to C39A

With the exception that the protective coating layer 13 is formed by use of a thermosetting resin having a hardness of A80, the coated polymer clad optical fiber 10 having high NA was produced in a way similar to the case of Test Example 1.

The excitation losses thereof were measured. As shown in Table 6, under the condition of the coated polymer clad optical fiber 10 in which the thickness of the polymer cladding layer 12 is 1.5 or more times the thickness of the protective coating layer 13, the value of the excitation loss does not increase, and the excitation loss was approximately 3 dB/km.

Regarding Numbers C37A to C39A of the coated polymer clad optical fibers 10 (having overall length of 20 km), in order to evaluate resistance to ironing of the produced coated polymer clad optical fibers 10, the coated polymer clad optical fibers were subjected to rewinding while being extended so as to be longer than the original length thereof by 2% of the length. Thereafter, visible light was launched into the optical fiber 11, and whether or not the excitation light leaked was evaluated. As a result of the evaluation, it was observed that the leakage of the excitation light (generation of bright spot) occurred at several portions due to ironing, and the excitation loss thereof increased by approximately 1.5 to 3.2 dB/km as compared with before the ironing.

TABLE 6

| | | | | | | DEGREE |
|---|---|---|---|---|---|---|
| | | | | | | OF |
| | | | | | THICKNESS | HARDNESS |
| | | | | | OF | OF |
| | | | PROTECTIVE | THICKNESS | PROTECTIVE | PROTECTIVE |
| | FIBER | CLADDING | COATING | OF | COATING | COATING |
| NUMBER | DIAMETER | DIAMETER | DIAMETER | CLADDING | LAYER | LAYER |
| C32A | 125 | 160 | 250 | 17.5 | 45 | A80 |
| C33A | 125 | 170 | 250 | 22.5 | 40 | A80 |
| C34A | 125 | 175 | 250 | 25 | 37.5 | A80 |
| C35A | 125 | 185 | 250 | 30 | 32.5 | A80 |
| C36A | 125 | 190 | 250 | 32.5 | 30 | A80 |
| C37A | 125 | 190 | 235 | 32.5 | 22.5 | A80 |
| C38A | 125 | 200 | 250 | 37.5 | 25 | A80 |
| C39A | 125 | 210 | 250 | 42.5 | 20 | A80 |

| | | | GENERATION | INCREMENT |
|---|---|---|---|---|
| | | | OF | IN |
| | THICKNESS | EXCITATION | BRIGHT | EXCITATION |
| NUMBER | RATIO | LOSS | SPOT | LOSS |
| C32A | 0.4 | 125 | — | — |
| C33A | 0.6 | 100 | — | — |
| C34A | 0.7 | 70 | — | — |
| C35A | 0.9 | 40 | — | — |
| C36A | 1.1 | 13 | — | — |
| C37A | 1.4 | 3 | PRESENCE | 2.3 |
| C38A | 1.5 | 2.9 | PRESENCE | 3.2 |
| C39A | 2.1 | 3.1 | PRESENCE | 1.5 |

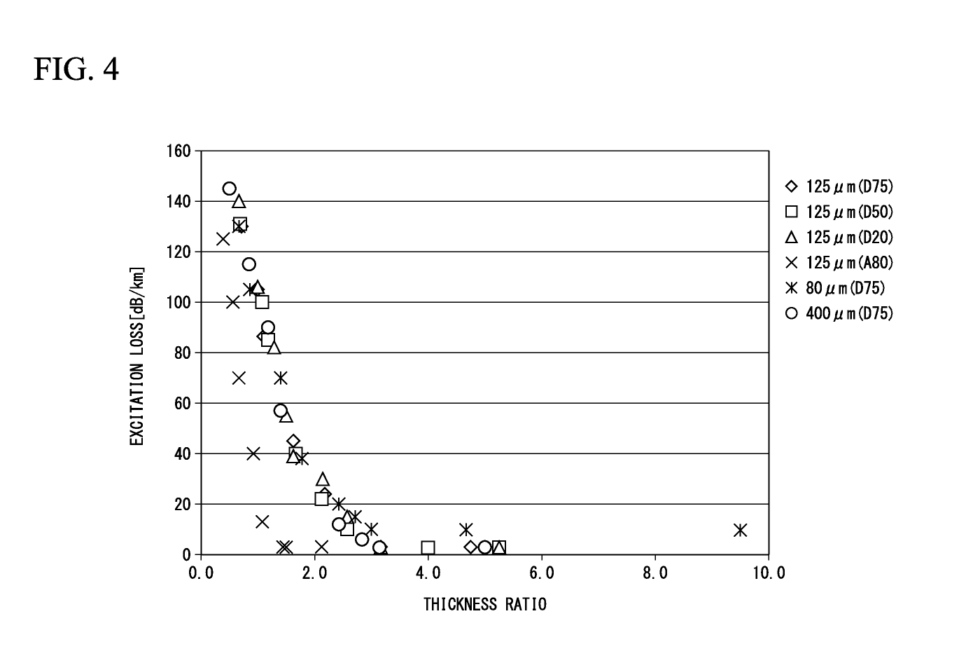

FIG. 4 is a chart collectively showing the relationships between thickness ratios according to the first embodiment and excitation losses (dB/km).

“125 μm (D75)” represents Test Example 1, “125 μm (D50)” represents Test Example 4, “125 μm (D20)” represents Test Example 5, “125 μm (A80)” represents Test Example 6, “80 μm (D75)” represents Test Example 2, and “400 μm (D75)” represents Test Example 3.

### Test Example of Second Embodiment

In the above-described second embodiment, a resin having a hardness of D20 or more is used to form the protective coating layer 24, and the total thickness of the polymer cladding layer 22 and the buffer layer 23 is 3.0 or more times the thickness of the protective coating layer 24. As a result, it is possible to manufacture the coated polymer clad optical fiber 20 that satisfies both resistance to ironing and a low degree of excitation loss.

Of the manufactured coated polymer clad optical fibers 20 shown in Tables 7 to 16, the coated polymer clad optical fibers which are represented by the number having the initial character denoted by “C” are Comparative Examples. That is, the coated polymer clad optical fibers shown by the numbers C1B to C50B represent Comparative Examples.

In Tables 7 to 16, the units of “FIBER DIAMETER”, “CLADDING DIAMETER”, “OUTER DIAMETER OF BUFFER LAYER”, “PROTECTIVE COATING DIAMETER”, “THICKNESS OF CLADDING”, “THICKNESS OF BUFFER LAYER”, “TOTAL THICKNESS OF CLADDING AND BUFFER LAYER”, and “THICKNESS OF PROTECTIVE COATING LAYER” are “μm”, the units of “EXCITATION LOSS” and “INCREMENT IN EXCITATION LOSS” are “dB/km”, and the units thereof which are commonly used are omitted.

The “FIBER DIAMETER” represents a glass diameter of the optical fiber 21. “CLADDING DIAMETER” and “THICKNESS OF CLADDING” represent the outer diameter and the thickness of the polymer cladding layer 22, respectively. “OUTER DIAMETER OF BUFFER LAYER” and “THICKNESS OF BUFFER LAYER” represent the outer diameter of and the thickness of the buffer layer 23, respectively. “PROTECTIVE COATING DIAMETER” and “THICKNESS OF PROTECTIVE COATING LAYER” represent the outer diameter of and the thickness of the protective coating layer 24, respectively. “TOTAL THICKNESS OF CLADDING AND BUFFER LAYER” represents the total of “THICKNESS OF CLADDING” and “THICKNESS OF BUFFER LAYER”.

“THICKNESS RATIO X” is the ratio of “THICKNESS OF CLADDING” to “THICKNESS OF BUFFER LAYER”.

“THICKNESS RATIO Y” is the ratio of “TOTAL THICKNESS OF CLADDING AND BUFFER LAYER” to “THICKNESS OF PROTECTIVE COATING LAYER”.

### Test Example 7

### Reference Numbers 1B to 3B and C1B to C5B

The fiber diameter of the optical fiber was 125 μm. The polymer cladding layer 22 was formed by use of a thermosetting resin having a refractive index of 1.35 or less, the buffer layer 23 was formed by use of a thermosetting resin having a hardness of A20, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 7, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 3 dB/km.

Next, regarding Numbers 1B to 3B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 7

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 1B | 125 | 170 | 230 | 300 | 22.5 | 30 | 52.5 | 35 |
| 2B | 125 | 170 | 200 | 250 | 22.5 | 15 | 37.5 | 25 |
| 3B | 125 | 190 | 240 | 300 | 32.5 | 25 | 57.5 | 30 |
| C1B | 125 | 145 | 160 | 250 | 10 | 7.5 | 17.5 | 45 |
| C2B | 125 | 145 | 185 | 300 | 10 | 20 | 30 | 57.5 |
| C3B | 125 | 160 | 195 | 300 | 17.5 | 17.5 | 35 | 52.5 |
| C4B | 125 | 170 | 210 | 300 | 22.5 | 20 | 42.5 | 45 |
| C5B | 125 | 170 | 210 | 290 | 22.5 | 20 | 42.5 | 40 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 1B | A20 | D75 | 0.8 | 1.5 | 3 | ABSENCE | 0 |
| 2B | A20 | D75 | 1.5 | 1.5 | 2.9 | ABSENCE | 0 |
| 3B | A20 | D75 | 1.3 | 1.9 | 3 | ABSENCE | 0 |
| C1B | A20 | D75 | 1.3 | 0.4 | 125 | — | — |
| C2B | A20 | D75 | 0.5 | 0.5 | 100 | — | — |
| C3B | A20 | D75 | 1.0 | 0.7 | 70 | — | — |
| C4B | A20 | D75 | 1.1 | 0.9 | 30 | — | — |
| C5B | A20 | D75 | 1.1 | 1.1 | 13 | — | — |

### Test Example 8

### Reference Numbers 4B to 8B and C6B to C11B

The fiber diameter of the optical fiber was 125 μm. The polymer cladding layer 22 was formed by use of a thermosetting resin having a refractive index of 1.35 or less, the buffer layer 23 was formed by use of a thermosetting resin having a hardness of A25, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 8, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 3 dB/km.

Next, regarding Numbers 4B to 8B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 8

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 4B | 125 | 170 | 230 | 300 | 22.5 | 30 | 52.5 | 35 |
| 5B | 125 | 170 | 200 | 250 | 22.5 | 15 | 37.5 | 25 |
| 6B | 125 | 190 | 250 | 305 | 32.5 | 30 | 62.5 | 27.5 |
| 7B | 125 | 170 | 270 | 305 | 22.5 | 50 | 72.5 | 17.5 |
| 8B | 125 | 150 | 200 | 230 | 12.5 | 25 | 37.5 | 15 |
| C6B | 125 | 160 | 185 | 300 | 17.5 | 12.5 | 30 | 57.5 |
| C7B | 125 | 160 | 190 | 300 | 17.5 | 15 | 32.5 | 55 |
| C8B | 125 | 160 | 195 | 300 | 17.5 | 17.5 | 35 | 52.5 |
| C9B | 125 | 170 | 210 | 300 | 22.5 | 20 | 42.5 | 45 |
| C10B | 125 | 170 | 215 | 300 | 22.5 | 22.5 | 45 | 42.5 |
| C11B | 125 | 190 | 225 | 300 | 32.5 | 17.5 | 50 | 37.5 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 4B | A25 | D75 | 0.8 | 1.5 | 2.9 | ABSENCE | 0 |
| 5B | A25 | D75 | 1.5 | 1.5 | 2.9 | ABSENCE | 0 |
| 6B | A25 | D75 | 1.1 | 2.3 | 3.1 | ABSENCE | 0 |
| 7B | A25 | D75 | 0.5 | 4.1 | 3 | ABSENCE | 0 |
| 8B | A25 | D75 | 0.5 | 2.5 | 3 | ABSENCE | 0 |
| C6B | A25 | D75 | 1.4 | 0.5 | 100 | — | — |
| C7B | A25 | D75 | 1.2 | 0.6 | 90 | — | — |
| C8B | A25 | D75 | 1.0 | 0.7 | 65 | — | — |
| C9B | A25 | D75 | 1.1 | 0.9 | 38 | — | — |
| C10B | A25 | D75 | 1.0 | 1.1 | 13 | — | — |
| C11B | A25 | D75 | 1.9 | 1.3 | 4.5 | — | — |

### Test Example 9

### Reference Numbers 9B to 12B and C12B to C17B

The fiber diameter of the optical fiber was 80 μm. The polymer cladding layer 22 was formed by use of a thermosetting resin having a refractive index of 1.35 or less, the buffer layer 23 was formed by use of a thermosetting resin having a hardness of A25, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 9, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 10 dB/km.

Next, regarding Numbers 9B to 12B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 9

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 9B | 80 | 110 | 215 | 300 | 15 | 52.5 | 67.5 | 42.5 |
| 10B | 80 | 120 | 230 | 300 | 20 | 55 | 75 | 35 |
| 11B | 80 | 150 | 270 | 300 | 35 | 60 | 95 | 15 |
| 12B | 80 | 150 | 280 | 300 | 35 | 65 | 100 | 10 |
| C12B | 80 | 110 | 135 | 250 | 15 | 12.5 | 27.5 | 57.5 |
| C13B | 80 | 110 | 145 | 250 | 15 | 17.5 | 32.5 | 52.5 |
| C14B | 80 | 110 | 150 | 250 | 15 | 20 | 35 | 50 |
| C15B | 80 | 110 | 165 | 250 | 15 | 27.5 | 42.5 | 42.5 |
| C16B | 80 | 120 | 170 | 250 | 20 | 25 | 45 | 40 |
| C17B | 80 | 120 | 175 | 250 | 20 | 27.5 | 47.5 | 37.5 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 9B | A25 | D75 | 0.3 | 1.6 | 10 | ABSENCE | 0 |
| 10B | A25 | D75 | 0.4 | 2.1 | 9.8 | ABSENCE | 0 |
| 11B | A25 | D75 | 0.6 | 6.3 | 10.2 | ABSENCE | 0 |
| 12B | A25 | D75 | 0.5 | 10.0 | 10.1 | ABSENCE | 0 |
| C12B | A25 | D75 | 1.2 | 0.5 | 131 | — | — |
| C13B | A25 | D75 | 0.9 | 0.6 | 103 | — | — |
| C14B | A25 | D75 | 0.8 | 0.7 | 71 | — | — |
| C15B | A25 | D75 | 0.5 | 1.0 | 37 | — | — |
| C16B | A25 | D75 | 0.8 | 1.1 | 23 | — | — |
| C17B | A25 | D75 | 0.7 | 1.3 | 16 | — | — |

### Test Example 10

### Reference Numbers 13B to 16B and C18B to C22B

The fiber diameter of the optical fiber was 400 μm. The polymer cladding layer 22 was formed by use of a thermosetting resin having a refractive index of 1.35 or less, the buffer layer 23 was formed by use of a thermosetting resin having a hardness of A25, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 10, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 3 dB/km.

Next, regarding Numbers 13B to 16B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 10

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 13B | 400 | 430 | 480 | 530 | 15 | 25 | 40 | 25 |
| 14B | 400 | 440 | 490 | 530 | 20 | 25 | 45 | 20 |
| 15B | 400 | 440 | 500 | 540 | 20 | 30 | 50 | 20 |
| 16B | 400 | 500 | 520 | 540 | 50 | 10 | 60 | 10 |
| C18B | 400 | 430 | 450 | 550 | 15 | 10 | 25 | 50 |
| C19B | 400 | 440 | 455 | 550 | 20 | 7.5 | 27.5 | 47.5 |
| C20B | 400 | 440 | 460 | 550 | 20 | 10 | 30 | 45 |
| C21B | 400 | 440 | 480 | 550 | 20 | 20 | 40 | 35 |
| C22B | 400 | 440 | 480 | 540 | 20 | 20 | 40 | 30 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 13B | A25 | D75 | 0.6 | 1.6 | 3 | ABSENCE | 0 |
| 14B | A25 | D75 | 0.8 | 2.3 | 3.2 | ABSENCE | 0 |
| 15B | A25 | D75 | 0.7 | 2.5 | 2.8 | ABSENCE | 0 |
| 16B | A25 | D75 | 5.0 | 6.0 | 3.1 | ABSENCE | 0 |
| C18B | A25 | D75 | 1.5 | 0.5 | 104 | — | — |
| C19B | A25 | D75 | 2.7 | 0.6 | 92 | — | — |
| C20B | A25 | D75 | 2.0 | 0.7 | 75 | — | — |
| C21B | A25 | D75 | 1.0 | 1.1 | 16 | — | — |
| C22B | A25 | D75 | 1.0 | 1.3 | 5.1 | — | — |

### Test Example 11

### Reference Numbers 17B to 20B and C23B to C26B

The fiber diameter of the optical fiber was 125 μm. The polymer cladding layer 22 was formed by use of a thermosetting resin having a refractive index of 1.35 or less, the buffer layer 23 was formed by use of a thermosetting resin having a hardness of A50, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 11, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 3 dB/km.

Next, regarding Numbers 17B to 20B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 11

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 17B | 125 | 170 | 200 | 250 | 22.5 | 15 | 37.5 | 25 |
| 18B | 125 | 190 | 235 | 300 | 32.5 | 22.5 | 55 | 32.5 |
| 19B | 125 | 190 | 240 | 300 | 32.5 | 25 | 57.5 | 30 |
| 20B | 125 | 190 | 250 | 300 | 32.5 | 30 | 62.5 | 25 |
| C23B | 125 | 150 | 170 | 250 | 12.5 | 10 | 22.5 | 40 |
| C24B | 125 | 150 | 175 | 250 | 12.5 | 12.5 | 25 | 37.5 |
| C25B | 125 | 160 | 190 | 250 | 17.5 | 15 | 32.5 | 30 |
| C26B | 125 | 170 | 195 | 250 | 22.5 | 12.5 | 35 | 27.5 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 17B | A50 | D75 | 1.5 | 1.5 | 2.8 | ABSENCE | 0 |
| 18B | A50 | D75 | 1.4 | 1.7 | 2.9 | ABSENCE | 0 |
| 19B | A50 | D75 | 1.3 | 1.9 | 2.8 | ABSENCE | 0 |
| 20B | A50 | D75 | 1.1 | 2.5 | 2.9 | ABSENCE | 0 |
| C23B | A50 | D75 | 1.3 | 0.6 | 105 | — | — |
| C24B | A50 | D75 | 1.0 | 0.7 | 75 | — | — |
| C25B | A50 | D75 | 1.2 | 1.1 | 33 | — | — |
| C26B | A50 | D75 | 1.8 | 1.3 | 8 | — | — |

### Test Example 12

### Reference Numbers 21B to 22B and C27B to C32B

The fiber diameter of the optical fiber was 125 μm. The polymer cladding layer 22 was formed by use of a thermosetting resin having a refractive index of 1.35 or less, the buffer layer 23 was formed by use of a thermosetting resin having a hardness of A75, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 12, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 3 dB/km.

Next, regarding Numbers 21B to 22B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 12

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 21B | 125 | 190 | 200 | 250 | 32.5 | 5 | 37.5 | 25 |
| 22B | 125 | 170 | 250 | 300 | 22.5 | 40 | 62.5 | 25 |
| C27B | 125 | 160 | 185 | 300 | 17.5 | 12.5 | 30 | 57.5 |
| C28B | 125 | 160 | 190 | 300 | 17.5 | 15 | 32.5 | 55 |
| C29B | 125 | 160 | 195 | 300 | 17.5 | 17.5 | 35 | 52.5 |
| C30B | 125 | 170 | 215 | 300 | 22.5 | 22.5 | 45 | 42.5 |
| C31B | 125 | 170 | 225 | 300 | 22.5 | 27.5 | 50 | 37.5 |
| C32B | 125 | 160 | 190 | 300 | 17.5 | 15 | 32.5 | 55 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 21B | A75 | D75 | 6.5 | 1.5 | 2.9 | ABSENCE | 0 |
| 22B | A75 | D75 | 0.6 | 2.5 | 2.9 | ABSENCE | 0 |
| C27B | A75 | D75 | 1.4 | 0.5 | 105 | — | — |
| C28B | A75 | D75 | 1.2 | 0.6 | 93 | — | — |
| C29B | A75 | D75 | 1.0 | 0.7 | 66 | — | — |
| C30B | A75 | D75 | 1.0 | 1.1 | 14 | — | — |
| C31B | A75 | D75 | 0.8 | 1.3 | 5.1 | — | — |
| C32B | A75 | D75 | 1.2 | 0.6 | 98 | — | — |

### Test Example 13

### Reference Numbers 23B to 24B and C33B to C37B

The fiber diameter of the optical fiber was 125 μm. The polymer cladding layer 22 was formed by use of a thermosetting resin having a refractive index of 1.35 or less, the buffer layer 23 was formed by use of a thermosetting resin having a hardness of A80, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 13, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 3 dB/km.

Next, regarding Numbers 23B to 24B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 13

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 23B | 125 | 170 | 200 | 250 | 22.5 | 15 | 37.5 | 25 |
| 24B | 125 | 190 | 240 | 300 | 32.5 | 25 | 57.5 | 30 |
| C33B | 125 | 160 | 200 | 300 | 17.5 | 20 | 37.5 | 50 |
| C34B | 125 | 160 | 210 | 300 | 17.5 | 25 | 42.5 | 45 |
| C35B | 125 | 160 | 220 | 300 | 17.5 | 30 | 47.5 | 40 |
| C36B | 125 | 160 | 195 | 250 | 17.5 | 17.5 | 35 | 27.5 |
| C37B | 125 | 170 | 195 | 245 | 22.5 | 12.5 | 35 | 25 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 23B | A80 | D75 | 1.5 | 1.5 | 2.9 | ABSENCE | 0 |
| 24B | A80 | D75 | 1.3 | 1.9 | 2.9 | ABSENCE | 0 |
| C33B | A80 | D75 | 0.9 | 0.8 | 62 | — | — |
| C34B | A80 | D75 | 0.7 | 0.9 | 43 | — | — |
| C35B | A80 | D75 | 0.6 | 1.2 | 13 | — | — |
| C36B | A80 | D75 | 1.0 | 1.3 | 10 | — | — |
| C37B | A80 | D75 | 1.8 | 1.4 | 4.5 | — | — |

### Test Example 14

### Reference Numbers C38B to C44B

The fiber diameter of the optical fiber was 125 μm. The polymer cladding layer 22 was formed by use of a thermosetting resin having a refractive index of 1.35 or less, the buffer layer 23 was formed by use of a thermosetting resin having a hardness of D20, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 14, even under the condition of the coated polymer clad optical fiber 20 in which the total thickness of the polymer cladding layer 22 and the buffer layer 23 is 1.5 or more times the thickness of the protective coating layer 24, the value of the excitation loss was greater than or equal to 10 dB/km.

In the case (C44B) of particularly reducing the thickness of the buffer layer 23, the value of the excitation loss was stable at approximately 3 dB/km.

TABLE 14

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| C38B | 125 | 175 | 205 | 250 | 25 | 15 | 40 | 22.5 |
| C39B | 125 | 190 | 230 | 250 | 32.5 | 20 | 52.5 | 10 |
| C40B | 125 | 200 | 235 | 250 | 37.5 | 17.5 | 55 | 7.5 |
| C41B | 125 | 215 | 250 | 270 | 45 | 17.5 | 62.5 | 10 |
| C42B | 125 | 220 | 250 | 270 | 47.5 | 15 | 62.5 | 10 |
| C43B | 125 | 230 | 250 | 270 | 52.5 | 10 | 62.5 | 10 |
| C44B | 125 | 235 | 250 | 270 | 55 | 7.5 | 62.5 | 10 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| C38B | D20 | D75 | 1.7 | 1.3 | 140 | — | — |
| C39B | D20 | D75 | 1.6 | 5.3 | 106 | — | — |
| C40B | D20 | D75 | 2.1 | 7.3 | 55 | — | — |
| C41B | D20 | D75 | 2.6 | 6.3 | 39 | — | — |
| C42B | D20 | D75 | 3.2 | 6.3 | 30 | — | — |
| C43B | D20 | D75 | 5.3 | 6.3 | 15 | — | — |
| C44B | D20 | D75 | 7.3 | 6.3 | 3 | — | — |

### Test Example 15

### Reference Numbers C45B to C50B

The fiber diameter of the optical fiber was 125 The polymer cladding layer 22 was formed by use of a thermosetting resin having a refractive index of 1.35 or less, the buffer layer 23 was formed by use of a thermosetting resin having a penetration of 45, and the protective coating layer 24 was formed by use of a thermosetting resin having a hardness of D75. As a result, the coated polymer clad optical fiber 20 having a high NA was produced.

The total thickness of the polymer cladding layer 22 and the buffer layer 23, and the thickness of the protective coating layer 24 were varied, the coated polymer clad optical fibers 20 using them were produced, and the excitation losses thereof were measured. As shown in Table 15, under the condition of the coated polymer clad optical fiber 20 in which the total thickness of the polymer cladding layer 22 and the buffer layer 23 is 1.5 or more times the thickness of the protective coating layer 24, the value of the excitation loss was stable at approximately 3 dB/km.

Regarding Numbers C48B to C50B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. In this case, it was observed that part of the coated polymer clad optical fiber 20 is deformed in appearance. Furthermore, visible light was launched into the optical fiber 21, and whether or not the excitation light leaked was evaluated. As a result of the evaluation, the leakage of the excitation light (generation of bright spot) occurred at the deformed part of the coated polymer clad optical fiber.

TABLE 15

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| C45B | 125 | 150 | 175 | 250 | 12.5 | 12.5 | 25 | 37.5 |
| C46B | 125 | 150 | 190 | 250 | 12.5 | 20 | 32.5 | 30 |
| C47B | 125 | 150 | 195 | 250 | 12.5 | 22.5 | 35 | 27.5 |
| C48B | 125 | 150 | 200 | 250 | 12.5 | 25 | 37.5 | 25 |
| C49B | 125 | 150 | 220 | 250 | 12.5 | 35 | 47.5 | 15 |
| C50B | 125 | 190 | 280 | 300 | 32.5 | 45 | 77.5 | 10 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| C45B | PENETRATION | D75 | 1.0 | 0.7 | 71 | — | — |
| | OF 45 | | | | | | |
| C46B | PENETRATION | D75 | 0.6 | 1.1 | 37 | — | — |
| | OF 45 | | | | | | |
| C47B | PENETRATION | D75 | 0.6 | 1.3 | 16 | — | — |
| | OF 45 | | | | | | |
| C48B | PENETRATION | D75 | 0.5 | 1.5 | 3.1 | PRESENCE | 5 |
| | OF 45 | | | | | | |
| C49B | PENETRATION | D75 | 0.4 | 3.2 | 3 | PRESENCE | 4 |
| | OF 45 | | | | | | |
| C50B | PENETRATION | D75 | 0.7 | 7.8 | 3.1 | PRESENCE | 6 |
| | OF 45 | | | | | | |

### Test Example 16

### Reference Numbers 25B to 29B

The fiber diameter of the optical fiber was 125 μm. The polymer cladding layer 22 was formed by use of a thermosetting resin having a refractive index of 1.35 or less, the buffer layer 23 was formed by use of a thermosetting resin having a hardness of A25, and the protective coating layer 24 was formed by use of a thermosetting resin having a hardness of D20. As a result, the coated polymer clad optical fiber 20 having a high NA was produced.

The ratio of total thickness of the polymer cladding layer 22 and the buffer layer 23 to the thickness of the protective coating layer 24 were fixed at 1.5, thicknesses of the polymer cladding layer 22 and the buffer layer 23 were varied, the coated polymer clad optical fibers 20 using them were produced, and the excitation losses thereof were measured. As shown in Table 16, the value of the excitation loss was approximately 3 dB/km in the range of 2.5 to 32.5 μm of the thickness of the polymer cladding layer 22.

Next, regarding Numbers 25B to 29B of the coated polymer clad optical fibers 20 (having overall length of 20 km), in order to evaluate resistance to ironing of the produced coated polymer clad optical fibers 20, the coated polymer clad optical fibers were subjected to rewinding while being extended so as to be longer than the original length thereof by 2% of the length. Thereafter, visible light was launched into the optical fiber 21, and whether or not the excitation light leaked was evaluated. As a result of the evaluation, it was observed that the leakage of the excitation light (generation of bright spot) did not occur, the excitation loss thereof was not varied, and excellent resistance to ironing was obtained.

TABLE 16

| | | | | | | | TOTAL | |
|---|---|---|---|---|---|---|---|---|
| | | | | | | | THICKNESS | |
| | | | OUTER | | | | OF | THICKNESS |
| | | | DIAMETER | | | THICKNESS | CLADDING | OF |
| | | | OF | PROTECTIVE | THICKNESS | OF | AND | PROTECTIVE |
| | FIBER | CLADDING | BUFFER | COATING | OF | BUFFER | BUFFER | COATING |
| NUMBER | DIAMETER | DIAMETER | LAYER | DIAMETER | CLADDING | LAYER | LAYER | LAYER |
| 25B | 125 | 180 | 200 | 250 | 27.5 | 10 | 37.5 | 25 |
| 26B | 125 | 130 | 200 | 250 | 2.5 | 35 | 37.5 | 25 |
| 27B | 125 | 140 | 200 | 250 | 7.5 | 30 | 37.5 | 25 |
| 28B | 125 | 160 | 200 | 250 | 17.5 | 20 | 37.5 | 25 |
| 29B | 125 | 190 | 200 | 250 | 32.5 | 5 | 37.5 | 25 |

| | | DEGREE | | | | | |
|---|---|---|---|---|---|---|---|
| | DEGREE | OF | | | | | |
| | OF | HARDNESS | | | | | |
| | HARDNESS | OF | | | | GENERATION | INCREMENT |
| | OF | PROTECTIVE | | | | OF | IN |
| | BUFFER | COATING | THICKNESS | THICKNESS | EXCITATION | BRIGHT | EXCITATION |
| NUMBER | LAYER | LAYER | RATIO X | RATIO Y | LOSS | SPOT | LOSS |
| 25B | A25 | D20 | 2.8 | 1.5 | 3.1 | ABSENCE | 0 |
| 26B | A25 | D20 | 0.1 | 1.5 | 3 | ABSENCE | 0 |
| 27B | A25 | D20 | 0.3 | 1.5 | 2.9 | ABSENCE | 0 |
| 28B | A25 | D20 | 0.9 | 1.5 | 3 | ABSENCE | 0 |
| 29B | A25 | D20 | 6.5 | 1.5 | 3.2 | ABSENCE | 0 |

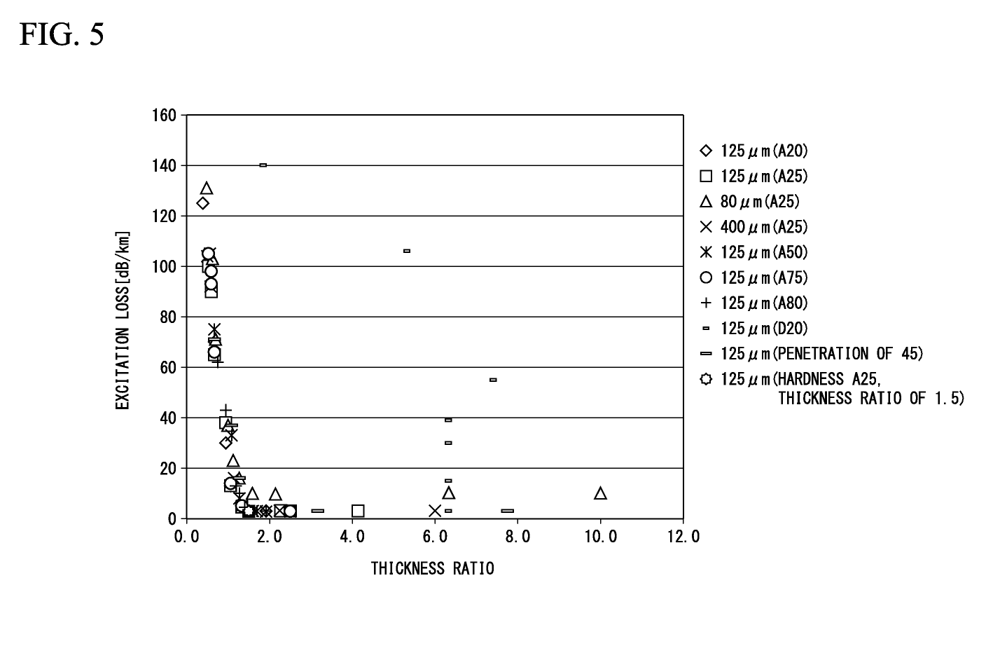

FIG. 5 is a chart collectively showing the relationships between thickness ratios (thickness ratio Y in Tables 7 to 16) according to the second embodiment and excitation losses (dB/km).

“125 μm (A20)” represents Test Example 7, “125 μm (A25)” represents Test Example 8, “80 μm (A25)” represents Test Example 9, “400 μm (A25)” represents Test Example 10, “125 μm (A50)” represents Test Example 11, “125 μm (A75)” represents Test Example 12, “125 μm (A80)” represents Test Example 13, “125 μm (D20)” represents Test Example 14, “125 μm (penetration 45)” represents Test Example 15, and “125 μm (A25, thickness ratio of 1.5)” represents Test Example 16.

What is claimed is:

1. A coated polymer clad optical fiber comprising:
a polymer cladding layer formed around an optical fiber made of silica-based glass, the polymer cladding layer having a refractive index lower than a refractive index of the silica-based glass; and
a protective coating layer formed around the polymer cladding layer; wherein
a thickness of the polymer cladding layer is 3.0 or more times a thickness of the protective coating layer.

2. The coated polymer clad optical fiber according to claim 1, wherein
the protective coating layer has a type D durometer hardness of greater than or equal to 20.

3. The coated polymer clad optical fiber according to claim 1, wherein
a resin used to form the protective coating layer is a thermosetting resin.

4. The coated polymer clad optical fiber according to claim 1, wherein
a resin used to form the polymer cladding layer is a thermosetting resin.

5. A coated polymer clad optical fiber comprising:
a polymer cladding layer formed around an optical fiber made of silica-based glass, the polymer cladding layer having a refractive index lower than a refractive index of the silica-based glass;
at least one or more buffer layers formed around the polymer cladding layer; and
a protective coating layer formed around the buffer layers, wherein
a total thickness of the polymer cladding layer and the buffer layers is 1.5 or more times a thickness of the protective coating layer.

6. The coated polymer clad optical fiber according to claim 5, wherein
the protective coating layer has a type D durometer hardness of greater than or equal to 20.

7. The coated polymer clad optical fiber according to claim 5, wherein
a resin used to form the protective coating layer is a thermosetting resin.

8. The coated polymer clad optical fiber according to claim 5, wherein
a resin used to form the buffer layers has a type A durometer hardness of 20 to 80.
